(19) United States
(12) Patent Application Publication
(10) Pub. No.: US 2016/0037935 A1
(43) Pub. Date: Feb. 11, 2016

(54) Chair Assembly

(71) Applicant: Theresa Piccioni, Mt. Royal, NJ (US)

(72) Inventor: Theresa Piccioni, Mt. Royal, NJ (US)

(21) Appl. No.: 14/451,539

(22) Filed: Aug. 5, 2014

(51) Int. Cl. A47C 20/04; A61G 7/075

(52) U.S. Cl. CPC A47C 20/04; A61G 7/075

(57) ABSTRACT

A chair assembly for supporting a user's arms while the user lays on the user's stomach includes a frame that may be positioned on a support surface. A plurality of legs is coupled to the frame. The plurality of legs abuts a support surface. The frame is supported above the support surface. A panel is coupled to the frame. The panel may support a user. A pair of arm rests is movably coupled to the frame. Each of the pair of arm rests supports the user's arms while the user lays on the panel.

### BACKGROUND OF THE DISCLOSURE

1. Field of the Disclosure

The disclosure relates to chair devices and more particularly pertains to a new chair device for supporting a user's arms while the user lays on the user's stomach.

2. Summary of the Disclosure

An embodiment of the disclosure meets the needs presented above by generally comprising a frame that may be positioned on a support surface. A plurality of legs is coupled to the frame. The plurality of legs abuts a support surface. The frame is supported above the support surface. A panel is coupled to the frame. The panel may support a user. A pair of arm rests is movably coupled to the frame. Each of the pair of arm rests supports the user's arms while the user lays on the panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a chair assembly according to an embodiment of the disclosure.

FIG. 2 is a top view of an embodiment of the disclosure.

FIG. 3 is a right side view of an embodiment of the disclosure.

FIG. 4 is a back view of an embodiment of the disclosure.

FIG. 5 is an in-use view of an embodiment of the disclosure.

### DESCRIPTION OF THE PREFERRED EMBODIMENT

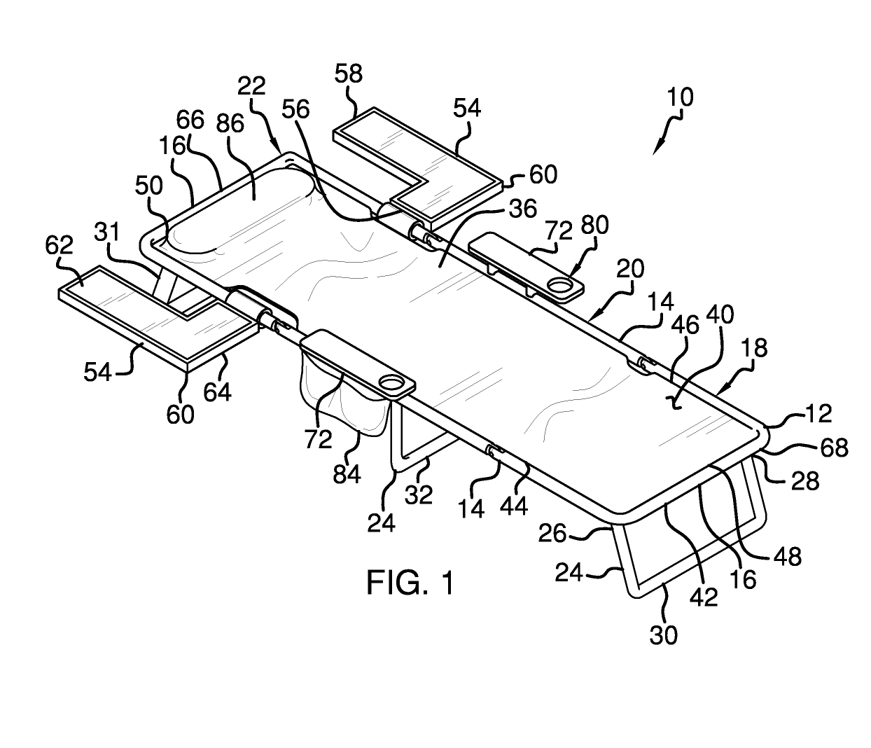

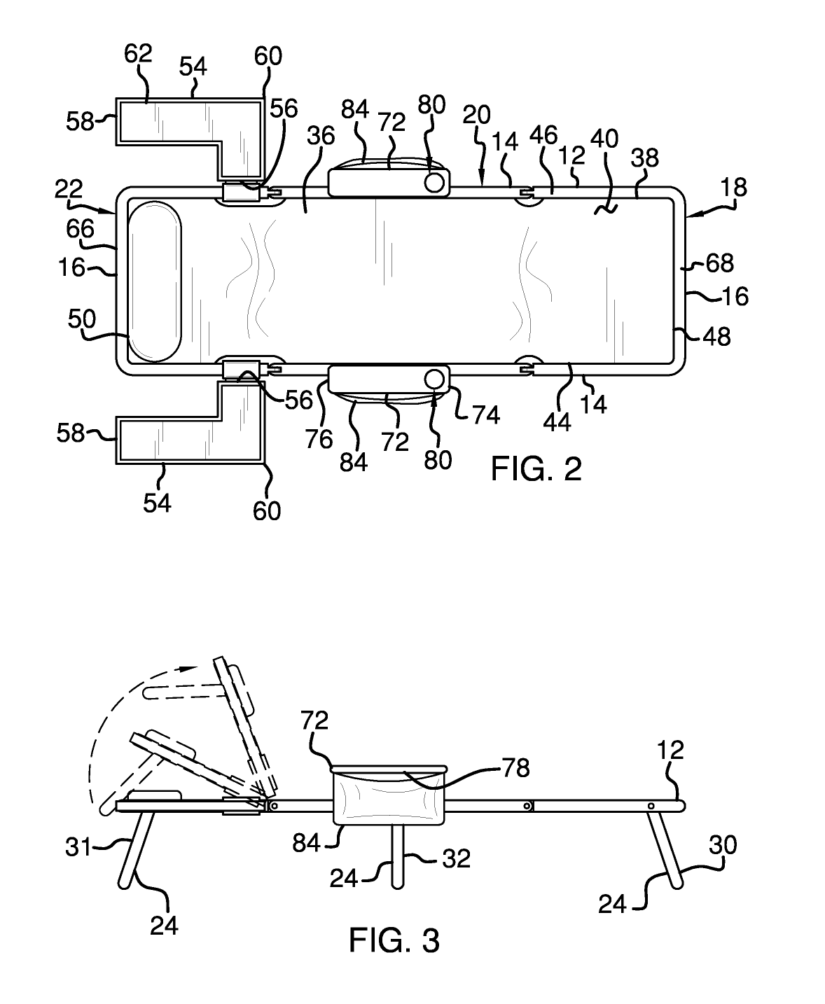

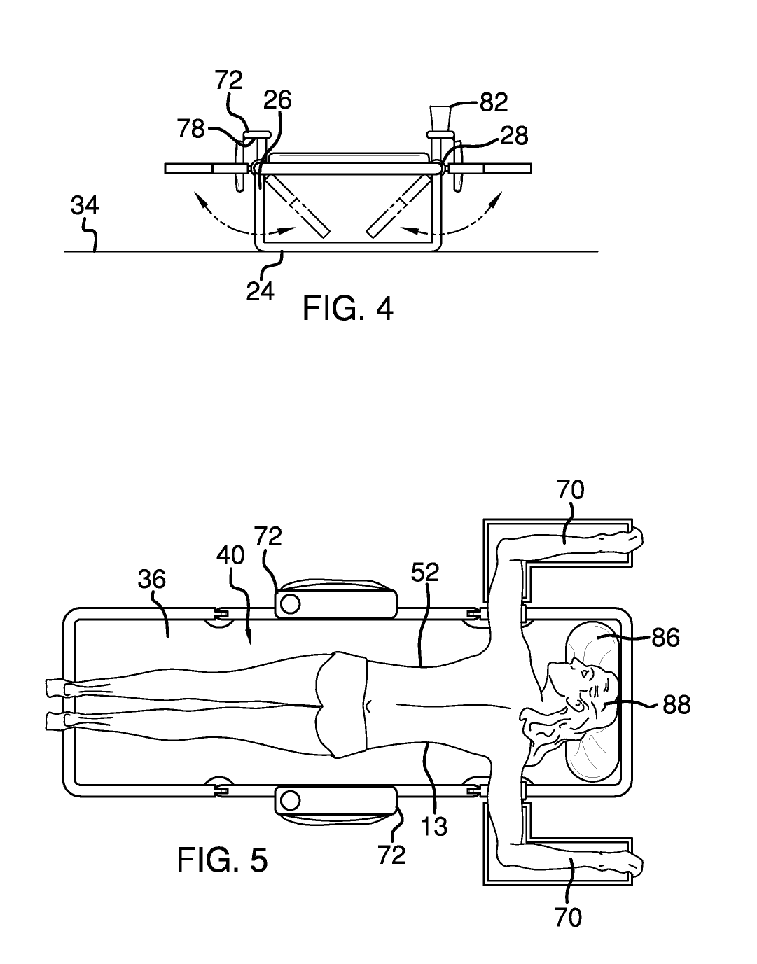

With reference now to the drawings, and in particular to FIGS. 1 through 5 thereof, a new chair device embodying the principles and concepts of an embodiment of the disclosure and generally designated by the reference numeral 10 will be described.

As best illustrated in FIGS. 1 through 5, the chair assembly 10 generally comprises a frame 12. The frame 12 includes a pair of longitudinal arms 14 of the frame 12 coupled to and extending between an associated one of opposite ends of each of a pair of lateral arms 16 of the frame 12. The pair of longitudinal arms 14 of the frame 12 are each divided into a front 18, central 20 and rear 22 section. The front section 18 of the pair of longitudinal arms 14 of the frame 12 is hingedly coupled to the central section 20 of the pair of longitudinal arms 14 of the frame 12. The rear section 22 of the pair of longitudinal arms 14 of the frame 12 are hingedly coupled to the central section 20 of the pair of longitudinal arms 14 of the frame 12. Each of the front 18 and rear 22 sections of the pair of longitudinal arms 14 of the frame 12 are positionable at a selected angle with respect to the central section 20 of the pair of longitudinal arms 14 of the frame 12.

A plurality of legs 24 is provided. Each of the plurality of legs 24 has a first end 26 and a second end 28. The plurality of legs 24 is bent such that the plurality of legs 24 has a U-shape. Moreover, the first 26 and second 28 ends of each of the plurality of legs 24 is movably coupled to each of the pair of longitudinal arms 14 of the frame 12. The plurality of legs 24 is evenly spaced apart and distributed between the pair of lateral arms 16 of the frame 12.

A front one 30 of the plurality of legs 24 is positioned on the front section 18 of the pair of longitudinal arms 14 of the frame 12. A central one 32 of the plurality of legs 24 is positioned on the central section 20 of the pair of longitudinal arms 14 of the frame 12. A rear one 31 of the plurality of legs 24 is positioned on the rear section 22 of the pair of longitudinal arms 14 of the frame 12. The plurality of legs 24 abuts a support surface 34. The frame 12 is supported above the support surface 34. Moreover, the support surface 34 may be ground.

A panel 36 is provided. The panel 36 has an outer edge 38 extending between each of a top surface 40 and a bottom surface 42 of the panel 36. Each of a first 44 and a second 46 lateral side of the outer edge 38 of the panel 36 is coupled to an associated one of the pair of longitudinal arms 14 of the frame 12. Each of a front side 48 and a back side 50 of the outer edge 38 of the panel 36 is coupled to an associated one of the pair of lateral arms 16 of the frame 12. The panel 36 may have a user 52 lie on the top surface 40 of the panel 36.

A pair of arm rests 54 each has a coupled end 56 and a free end 58. Each of the pair of arm rests 54 is elongated. Each of the pair of arm rests 54 has a medially positioned bend 60. Each of the pair of arm rests 54 has an L-shaped cross section taken perpendicular to a line extending through a top side 62 and a bottom side 64 of each of the pair of arms rests 54. The coupled end 56 of each of the pair of arm rests 54 is movably coupled to an associated one of a pair of longitudinal arms 14 of the frame 12.

The free end 58 of each of the pair of arms rests 54 is directed toward a back one 66 of the pair of lateral arms 16 of the frame 12. Each of the pair of arm rests 54 is positioned closer to the back lateral arm 66 of the frame 12 than a front one 68 of the pair of lateral arms 16 of the frame 12. The pair of arm rests 54 is each positionable in a deployed position. The top side 62 of each of the pair of arm rests 54 lies on a plane that is planar with the top surface 40 of the panel 36. The top side 62 of each of the pair of arm rests 54 supports an associated one of the user's arms 70 while the user 52 lays on the panel 36. Each of the pair of arm rests 54 is positionable in a stored position. The pair of arm rests 54 each extends downwardly from the pair of longitudinal arms 14 of the frame 12.

A pair of cup holders 72 is provided. The pair of cup holders 72 each has a front end 74 and a back end 76. A lower side 78 of each of the pair of cup holders 72 is coupled to an associated one of the pair of longitudinal arms 14 of the frame 12. The pair of cup holders 72 is spaced above the pair of longitudinal arms 14 of the frame 12.

The pair of cup holders 72 each has a cup hole 80 extending through an upper side 82 and the lower side 78 of the pair of cup holders 72. The cup hole 80 is positioned proximate the front end 74 of the associated one of the pair of cup holders 72. The cup hole 80 may insertably receive a container 82. A pair of pouches 84 is coupled to the lower side 78 of an associated one of the pair of cup holders 72. The pair of pouches 84 may each be used for storage.

A pillow 86 is coupled to the top surface 40 of the panel 36. The pillow 86 is positioned proximate the back side 50 of the outer edge 38 of the panel 36. Additionally, the pillow 86 may support the user's head 88 when the user 52 lies on the panel 36.

In use, the user 52 lies on the panel 36 on the user's stomach 13. The pair of arm rests 54 are positioned in the deployed position. The user 52 positions each of the user's arms 70 on an associated one of the pair of arm rests 54. The pair of arm rests 54 supports the user's arms 70 while the user 52 sunbathes.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A chair assembly configured to support a user's arms while the user lays on the user's stomach on said assembly, said assembly comprising:
a frame configured to be positioned on a support surface;
a plurality of legs coupled to said frame, said plurality of legs abutting the support surface such that said frame is supported above the support surface;
a panel coupled to said frame such that said panel is configured to support a user; and
a pair of arm rests movably coupled to said frame, each of said arm rests supporting the user's arms while the user lays on said panel, wherein each of said pair of arm rests having a coupled end and a free end, each of said pair of arm rests being elongated, each of said pair of arm rests having a medially positioned bend such that each of said pair of arm rests has an L-shaped cross section taken perpendicular to a line extending through a top side and a bottom side of each of said pair of arms rests, said coupled end of each of said pair of arm rests each being movably coupled to an associated one of a pair of longitudinal arms of said frame such that said free end of each of said pair of arms rests is directed toward a back one of a pair of lateral arms of said frame, each of said pair of arm rests being positioned closer to said back lateral arm of said frame than a front one of said pair of lateral arms of said frame.

2. The assembly according to claim 1, wherein said frame comprising a pair of longitudinal arms of said frame coupled to and extending between an associated one of opposite ends of each of a pair of lateral arms of said frame.

3. The assembly according to claim 2, further comprising each of said plurality of legs having a first end and a second end, said plurality of legs being bent such that said plurality of legs has a U-shape.

4. The assembly according to claim 3, further comprising said first and second ends of each of said plurality of legs being movably coupled to each of said pair of longitudinal arms of said frame, said plurality of legs being evenly spaced apart and distributed between said pair of lateral arms of said frame

5. The assembly according to claim 2, further comprising said panel having an outer edge extending between each of a top surface and a bottom surface of said panel, each of a first and a second lateral side of said outer edge of said panel being coupled to an associated one of said pair of longitudinal arms of said frame, each of a front side and a back side of said outer edge of said panel being coupled to an associated one of said pair of lateral arms of said frame.

6. The assembly according to claim 5, wherein said panel is configured to have the user lie on said top surface of said panel.

7. (canceled)

8. The assembly according to claim 1, further comprising each of said pair of arm rests being positionable in a deployed position such that said top side of each of said pair of arm rests lies on a plane being planar with a top surface of said panel.

9. The assembly according to claim 1, further comprising each of said pair of arm rests being positionable in a stored position having each of said pair of arm rests extending downwardly from said pair of longitudinal arms of said frame.

10. A chair assembly configured to support a user's arms while the user lays on the user's stomach on said assembly, said assembly comprising:
a frame comprising a pair of longitudinal arms of said frame coupled to and extending between an associated one of opposite ends of each of a pair of lateral arms of said frame;
a plurality of legs, each of said plurality of legs having a first end and a second end, said plurality of legs being bent such that said plurality of legs has a U-shape, said first and second ends of each of said plurality of legs being movably coupled to each of said pair of longitudinal arms of said frame, said plurality of legs being evenly spaced apart and distributed between said pair of lateral arms of said frame, said plurality of legs abutting the support surface such that said frame is supported above the support surface;
a panel having an outer edge extending between each of a top surface and a bottom surface of said panel, each of a first and a second lateral side of said outer edge of said panel being coupled to an associated one of said pair of longitudinal arms of said frame, each of a front side and a back side of said outer edge of said panel being coupled to an associated one of said pair of lateral arms of said frame wherein said panel is configured to have the user lie on said top surface of said panel;
a pair of arm rests each having a coupled end and a free end, each of said pair of arm rests being elongated, each of said pair of arm rests having a medially positioned bend such that each of said pair of arm rests has an L-shaped cross section taken perpendicular to a line extending through a top side and a bottom side of each of said pair of arms rests, said coupled end of each of said pair of arm rests each being movably coupled to an associated one of a pair of longitudinal arms of said frame such that said free end of each of said pair of arms rests is directed toward a back one of a pair of lateral arms of said frame, each of said pair of arm rests being positioned closer to said back lateral arm of said frame than a front one of said pair of lateral arms of said frame;
each of said pair of arm rests being positionable in a deployed position such that said top side of each of said pair of arm rests lies on a plane being planar with said top surface of said panel, said top side of each of said pair of arm rests supporting the user's arms while the user lays on said panel; and
each of said pair of arm rests being positionable in a stored position having each of said pair of arm rests extending downwardly from said pair of longitudinal arms of said frame.
